(19) United States
(12) Patent Application Publication
(10) Pub. No.: US 2025/0333249 A1
(43) Pub. Date: Oct. 30, 2025

(54) CONVEYOR BELT ASSEMBLY

(71) Applicant: World Wide Serpent ApS, Ålbæk (DK)

(72) Inventor: Christian LINDGREN, Ålbæk (DK)

(21) Appl. No.: 19/195,354

(22) Filed: Apr. 30, 2025

Related U.S. Application Data
(60) Provisional application No. 63/640,491, filed on Apr. 30, 2024.

(30) Foreign Application Priority Data
Apr. 30, 2024 (EP) 24173448.2

(51) Int. Cl. B65G 17/12; A01K 99/00

(52) U.S. Cl. CPC B65G 17/12; A01K 99/00

(57) ABSTRACT

A conveyor belt assembly for conveying fish includes belt links each having a body defining a width, height and length. The body has a first end part with a first connecting member having a first width (SW), and a second end part with a second connecting member. The second connecting member consists of at least two arms, each having a second width, and the first and the second connecting members have holes. A pin is arranged in the holes to connect the first connecting member with the second connecting member of a second belt link via the holes in the connecting members. The combined width of the at least two arms has a second width that is more than 98% of the first width.

The present invention relates to a conveyor belt assembly for conveying of fish.

Fishing boats at sea are in fact fully operational production facilities that rely highly on the quality of the individual stations in the production process. Hence, much effort is put into optimising every step of the process. Even optimisations that seem small may have a large impact on a production running 24/7 and being at sea without the direct possibility of calling for spare parts or people to repair broken equipment.

In general, it is important that the production of fish is kept running at all costs since the breakdown of a single station in the process causes disturbances to the flow of the whole production.

As is well known to most people, fish are generally slippery, which even further increases the problems of having to handle the fish individually in a controlled manner.

In the fishing industry, a major part of the production is merely the physical moving of the fish in a desired manner. A large number of machines rely on the correct orientation and positioning of the fish in relation to the process to be carried out.

When cutting fish like mackerel, herring and similar fish into filets, the fish is handled in an upright position during the cutting. Traditional conveyor belts only handle the slippery fish with difficulty, and hence the conveyor belts are configured with means for getting a stronger grip on the fish in order to move the fish in a fast and precise manner.

This means that the fish is not only carried lying on the conveyor belt but is actually forced forward by way of the conveyor belt getting a strong hold of the fish and dragging it forward.

The gripping means of the conveyor belt causes the conveyor belt to be subjected to a very sudden force impact when the conveyor belt comes into contact with a fish.

Although sudden forces are subjected to the conveyor belt, the conveyor belt still needs to be strong and reliable, easy to clean as well as capable of providing a working environment that does not make too much/excessive noise.

Often, conveyor belts break at sea and need replacement, causing a production stop at a highly inconvenient time. It would seem obvious to fully solve the problem of breaking of the belt. However, the conveyor belt needs to break in a way that does not cause any breaking of other parts of the machinery. If, for example, the conveyor belt is fully made of hardened stainless steel, breaking of the conveyor belt may cause various other damage to the machinery that is more difficult to repair at sea. Hence, even small changes to the conveyor belt have large effects and are therefore carefully considered.

It is an object of the present invention to wholly or partly overcome the above disadvantages and drawbacks of the prior art. More specifically, it is an object to provide an improved conveyor belt that is stronger and more reliable than known solutions.

It is a further object of the invention to present a conveyor belt that is cheap to manufacture and still fits existing equipment.

The above objects, together with numerous other objects, advantages and features, which will become evident from the below description, are accomplished by a solution in accordance with the present invention in the form of a conveyor belt assembly for conveying of fish, comprising:
a plurality of belt links, each belt link having a body defining a width transversal to a longitudinal extension of the belt assembly, and a height and a length defined along the longitudinal extension of the belt assembly,
the body of the belt link comprising a first end part and a second end part, the first end part comprising a first connecting member having a first width, and the second end part comprising a second connecting member, wherein the second connecting member consists of at least two arms, each having a second width,
the first and the second connecting members comprising holes, and
a pin arranged in the holes to connect the first connecting member of a first belt link with the second connecting member of a second belt link via the holes in the connecting members,
wherein the combined width of the at least two arms each having a second width is more than 98% of the first width of the first connecting member.

In this way, it is achieved that the strength of the joint between two belt links is increased. This is because the two connecting members are evenly worn and because the material strength of the first connecting end part is substantially the same as that of the second connecting end part due to the equal width of the connecting parts.

Moreover, the width of the body of the belt links may be substantially equal to the combined width of the first connecting member and the second connecting member.

In an embodiment the belt link may comprise a spike hole that may be a blind hole.

Furthermore, the first connecting member of a first belt link may be adapted to be arranged between two arms of the second connecting member and so forth to create an endless conveyor belt assembly.

Also, each belt link may further comprise a spike.

In this way, it is achieved that the conveyor belt is capable of getting a firm grip of or even penetrating the subject to be moved or propelled forward.

In addition, the spike may be made from a material different than a link body. In addition, the spike may be made from a material different than the general body of the belt link.

In this way, it is achieved that the spike maintains its capability of penetrating or gripping the skin of e.g. a fish, whereby efficient propelling is achieved.

In a yet another embodiment of the invention the conveyor belt assembly for conveying of fish, may comprises:
a plurality of belt links, each belt link having a body defining a width transversal to a longitudinal extension of the belt assembly, and a height and a length defined along the longitudinal extension of the belt assembly,
the body of the belt link comprising a first end part and a second end part, the first end part comprising a first connecting member having a first width, and the second end part comprising a second connecting member, wherein the second connecting member consists of at least two arms, each having a second thickness,
the first and the second connecting members comprising holes, and
a pin arranged in the holes to connect the first connecting member of a first belt link with the second connecting member of a second belt link via the holes in the connecting members,
wherein the combined width of the at least two arms is more than 98% of a first thickness of the first connecting member.

Moreover, the body of the belt links may be monolithic.

In this way, it is achieved that the belt link has a uniform strength that does not depend on assembled or different materials. Furthermore, the manufacturing of the individual belt links may be carried out by injection moulding. In this way, easy and cheap manufacturing of the belt links is achieved.

Additionally, the body of the belt links may be made of a composite.

In this way, it is achieved that the strength of the belt links may be further increased. The strength or durability may be increased in the belt link as a whole or in specific areas such as the holes or the arms of the second connecting member.

Further, the belt links may be made from POM/acetal.

In this way, it is achieved that the belt link is directly usable in the food industry since this material is not poisonous in any sense, and even if bits crack off, they do not harm humans. Furthermore, this material is very durable, e.g. POM 1000 increases the lifespan of the belt link and as such the whole conveyer belt assembly. The contact between e.g. stainless steel and POM/acetal reduces noise compared to stainless steel in contact with stainless steel. Hence, the wellbeing of the workers is increased.

Also, the pin may be made from a different material than the belt links. The pin may be made from stainless steel or aluminium. The pin may have a diameter of 4 mm-5.5 mm, more preferred 4.1 mm-5.3, further preferred 4.2 mm-5.1 mm, and most preferred 4.3 mm-4.9 mm.

The pin may be milled instead of cast or sintered. In this way, the exact tolerances of the diameter are achieved. Hence, the fitting of the pin in the holes does not introduce stress to the belt link. Furthermore, an even distribution of forces between the pin and the holes is achieved.

By having a pin of a different material, it is achieved that the pin may be reused when changing the belt. Furthermore, it is ensured that no cracks are hidden in the pin since the pin is stronger than the belt link.

In addition, the body of the belt links may be monolithic.

The width of the material of the first connecting member may be smaller than the width of the material of the second connecting member, i.e. the combined width of each of the arms of the second connecting member. The first connecting member may be 0.1 mm-0.5 mm smaller than the combined width of the second connecting member.

The diameter of the pin may be 50% or more than the diameter of the material radially surrounding the pin along at least a part of the longitudinal extension of the pin. The longitudinal extension is 90° to the radial extension. The diameter of the material surrounding the pin may not be a full circle and hence considering the “diameter” is to be understood as if a circle was drawn concentrically with the centre of the pin, then the pin measured diameter of the pin is 50% or more than the combined material on each side of the pin measured along the same line as the diameter of the pin.

The hole of the first connecting member may have a larger diameter than the hole(s) of the second connecting member. In this way, it is achieved that the belt link swivels more freely between the pin and the first connecting member than between the pin and the second connecting member. Thus, it is achieved that wear and tear take place in a controlled manner in a known place.

Moreover, the belt link may comprise bushings in the holes. The bushing may be in the hole of the first connecting member and/or the hole of the second connecting member. In this way, it is achieved that wear and tear are further controlled, and hence the breaking of the conveyor belt as a whole is controlled.

Further, the connecting members of the belt links may comprise a second material, e.g. stainless steel.

In this way, it is achieved that the connecting members are made even stronger, and the lifespan of the conveyer belt is increased.

Additionally, the first connecting member of a first belt link may be adapted to be arranged between two arms of the second connecting member and so forth to create an endless belt assembly.

Moreover, the present invention further comprises a fish-conveying machine comprising a conveyor belt assembly.

Finally, the present invention also relates to use of the conveyor belt assembly for conveying fish.

The invention and its many advantages will be described in more detail below with reference to the accompanying schematic drawings, which for the purpose of illustration show some non-limiting embodiments and in which:

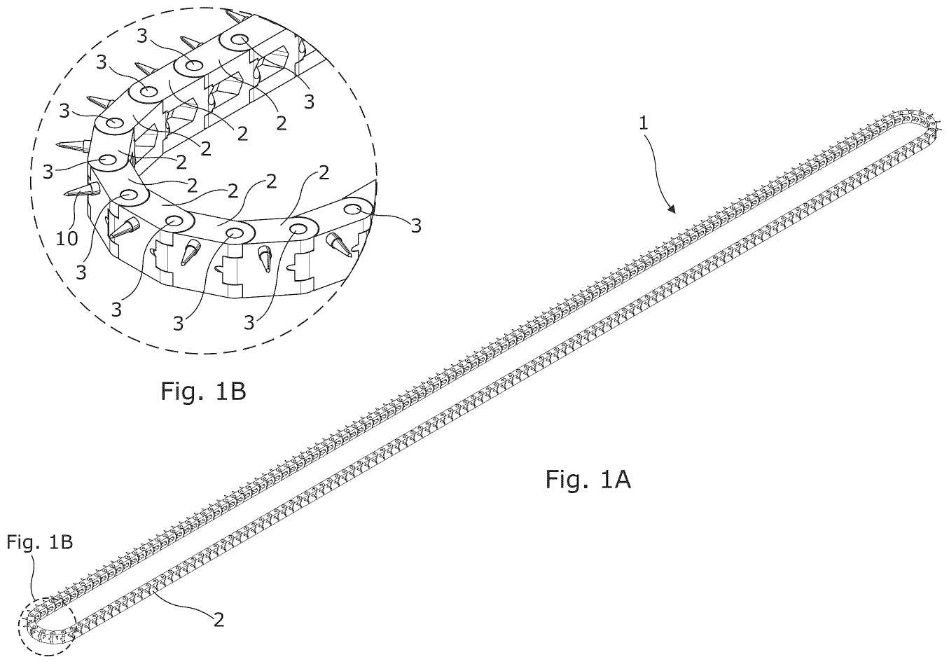

FIG. 1A shows a conveyor belt according to the invention,

FIG. 1B shows an enlarged cut-out of the conveyor belt shown in FIG. 1A,

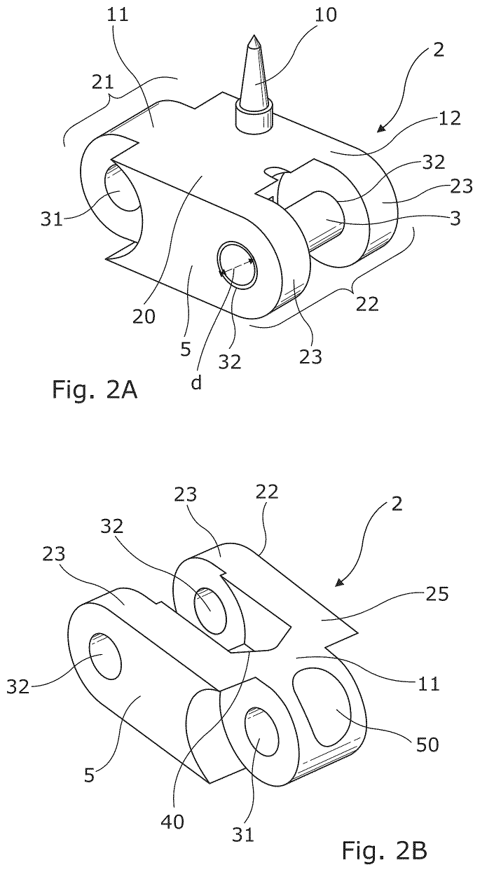

FIG. 2A shows, in a perspective view, a belt link of the conveyor belt,

FIG. 2B shows, in a perspective view, a belt link of the conveyor belt,

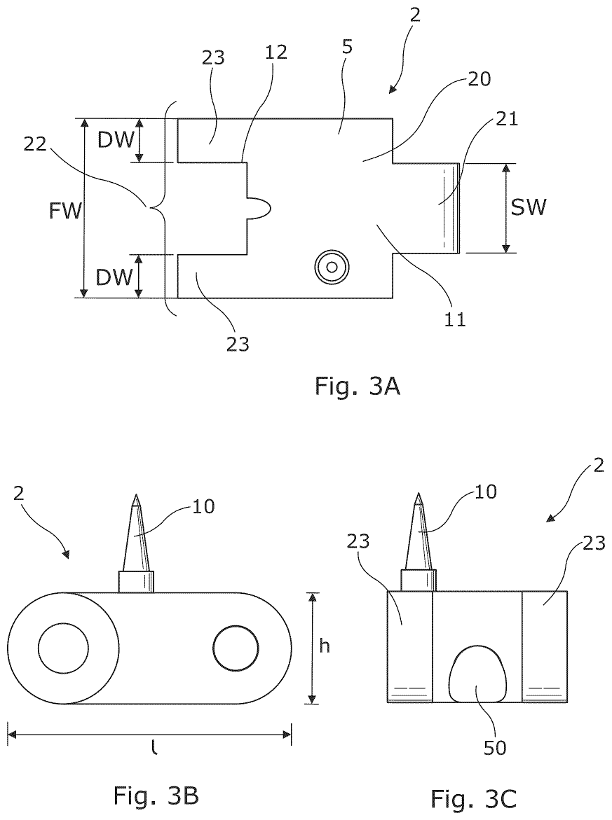

FIG. 3A shows a belt link of the conveyor belt seen directly from above the spike side,

FIG. 3B shows a side view of the belt link shown in FIG. 3A,

FIG. 3C shows an end view of the belt link shown in FIG. 3A,

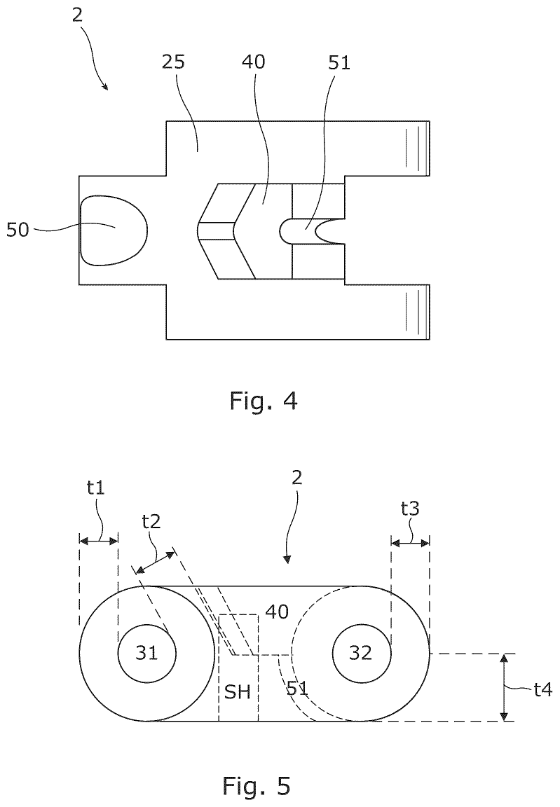

FIG. 4 shows a belt link of the conveyor belt seen directly from the interfacing side, and

FIG. 5 shows a side view of a belt link having the cut-outs indicated by dotted lines.

All the figures are highly schematic and not necessarily to scale, and they show only those parts which are necessary in order to elucidate the invention, other parts being omitted or merely suggested.

FIGS. 1A and 1B show a conveyor belt assembly 1, also named a conveyor belt 1, for conveying fish. The conveyor belt 1 comprises a plurality of belt links 2. The belt links 2 are held together by pins 3 and thereby forms a conveyor belt 1. The conveyor belt 1 forms a closed loop adapted to be placed in guides in a machine (not shown) for dragging or moving fish from one position to another. It is shown that each belt link 2 comprises a spike 10 to engage with the fish and hence firmly grip the fish and drag the fish in the direction of rotation to the closed loop.

FIGS. 2A and 2B show, in a perspective view, an embodiment of a belt link 2. FIG. 2A shows the belt link 2 shown from a spike side 20, and FIG. 2B shows the belt link 2 from an interface side 25. The interface side 25 is adapted to receive teeth or the like from e.g. an electric motor to move the conveyor belt 1. A body 5 of the belt link 2 comprises a first end part 11 and a second end part 12. The first end part 11 comprises a first connecting member 21, and the second end part 12 comprises a second connecting member 22 consisting of at least two arms 23. The first end part 11 is arranged with first holes 31, and the second end part 12 is arranged with second holes 32. Both of the holes 31, 32 in the first and the second end parts 11, 12 are adapted to receive a pin 3 having a diameter d in order to connect a first belt link 2 to a second belt link 2 (assembly not shown). Similarly to FIG. 2A, FIG. 2B shows a belt link 2 shown from the interface side 25. The second end part is shown without the pin 3. The interface side 25 comprises a cut-out 40 adapted to receive a tooth or similar projection from propelling means in order to move the conveyor belt 1 as a whole (not shown).

The pin 3 shown in FIG. 2A has a diameter d. The pin 3 may have a diameter d of 4 mm-5.5 mm. In the shown embodiment, the diameter d of the pin 3 is 4.3 mm. The diameter d of the pin 3 may be equal to or more than 50% of the material of the belt link 2 surrounding the pin 3. The pin 3 may be milled, and therefore an exact fit is achieved between the holes 31, 32 and the pin 3. The hole 31 of the first connecting member 21 may have a larger diameter than the hole(s) 32 of the second connecting member 22. In this way, it is achieved that the belt link 2 swivels more freely between the pin 3 and the first connecting member 21 than between the pin 3 and the second connecting member 22. An indentation 50 is shown.

FIGS. 3A-3C show different views of a belt link 2. FIG. 3A shows that the first connecting member 21 consists of one arm projecting from the body 5 of the belt link 2. The first connecting member 21 has a width SW when measured perpendicularly to the spike side 20. Measured in the same direction, the second connecting member 22 comprises two arms 23, each having a width DW. The body 5 of the belt link 2 defines a full width FW. It is shown that in this embodiment of the invention the combined width of the arms 23 of the second connecting member 22, i.e. two times the width DW, substantially equals the width SW of the first connecting member 21. In this way, the width SW of the first connecting member 21 is more than 95% of the combined width DW of the two arms 23 of the second connecting member 22.

Hence, FIGS. 2A-3C show that each belt link 2 has a body 5 defining a width FW transversal to the longitudinal extension of the belt assembly 1, and a height h and a length/defined along the longitudinal extension of the belt assembly 1.

The body 5 of the belt link 2 comprises a first end part 11 and a second end part 12, the first end part 11 comprising a first connecting member 21 having a first width SW, and the second end part 12 comprising a second connecting member 22 wherein the second connecting member 22 consisting of at least two arms 23, each having a second width DW. The first and second connecting members 21, 22 comprise holes 31, 32, a pin 3 being arranged in the holes 31, 32 to connect the first connecting member 21 of a first belt link 2 with the second connecting member 22 of a second belt link 2 via the holes 31, 32 in the connecting members 21, 22, wherein the combined width of the at least two arms 23 is more than 98% of the first width of the first connecting member 21.

FIG. 4 shows an embodiment of a belt link 2 seen from the interfacing side 25. The belt link 2 comprises a cut-out 40 in which means for propelling or moving the conveyor belt assembly 1 will engage. Furthermore, an indentation 50 and a half-pipe 51 are shown. Both the indentation 50 and the half-pipe 51 ensure that neither water nor air may be trapped between two neighbouring, i.e. connected, belt links. If the propelling means (not shown) is inserted in the cut-out 40, e.g. water, fish scales or dirt need to have a way to be ejected.

FIG. 5 shows a belt link 2 in a partly see-trough view. It is shown that of thicknesses t1-t4, the thicknesses t1 and t3 are the smallest. Hence, it is controlled that the belt link 2 as a whole will break at t1 or t3 before t2 or t4. The cut-out 40, a spike blind-hole SH and the holes 31, 32 for the pin 3 connecting to belt links (not shown) are also shown. It is shown that the diameter of the holes 31, 32 is at least 45% of the thicknesses t1 and t3. Since the holes 31, 32 are adapted to receive the pin 3 (not shown), the diameter of the pin 3 is at least 45% of the height h of the body as shown in FIG. 3B.

Although the invention has been described above in connection with preferred embodiments of the invention, it will be evident to a person skilled in the art that several modifications are conceivable without departing from the invention as defined by the following claims.

1. Conveyor belt assembly for conveying of fish, comprising:
a plurality of belt links, each belt link having a body defining a width transversal to a longitudinal extension of the belt assembly, and a height and a length defined along the longitudinal extension of the belt assembly,
the body of the belt link comprising a first end part and a second end part, the first end part comprising a first connecting member having a first width (SW), and the second end part comprising a second connecting member, wherein the second connecting member consists of at least two arms, each having a second width (DW),
the first and the second connecting members comprising holes, and
a pin arranged in the holes to connect the first connecting member of a first belt link with the second connecting member of a second belt link via the holes in the connecting members,
wherein the combined width of the at least two arms each having a second width (DW) is more than 98% of the first width (SW) of the first connecting member.

2. Conveyor belt assembly according to claim 1, wherein the width of the body of the belt links substantially equals the combined width of the first connecting member and the second connecting member.

3. Conveyor belt assembly according to claim 1, wherein the first connecting member of a first belt link is adapted to be arranged between two arms of the second connecting member and so forth to create an endless conveyor belt assembly.

4. Conveyor belt assembly according to claim 1, wherein each belt link further comprises a spike.

5. Conveyor belt assembly according to claim 1, wherein the spike is made from a material different from that of the link body.

6. Conveyor belt assembly according to claim 1, wherein the body of the belt links is monolithic.

7. Conveyor belt assembly according to claim 1, wherein the body of the belt links is made of a composite.

8. Conveyor belt assembly according to claim 1, wherein the belt links are made from POM/acetal.

9. Conveyor belt assembly according to claim 1, wherein the pin is made from a different material than the belt links.

10. Conveyor belt assembly according to claim 1, wherein a spike hole is a blind hole.

11. Conveyor belt assembly according to claim 1, wherein the belt link comprises bushings in the holes.

12. Conveyor belt assembly according to claim 1, wherein the connecting members of the belt links comprise a second material, e.g. stainless steel.

13. Conveyor belt assembly according to claim 1, wherein the first connecting member of a first belt link is adapted to be arranged between two arms of the second connecting member and so forth to create an endless belt assembly.

14. Fish-conveying machine comprising a conveyor belt assembly according to claim 1.

15. Use of the conveyor belt assembly according to claim 1 for conveying fish.
